(19) United States
(12) Patent Application Publication
(10) Pub. No.: US 2021/0401231 A1
(43) Pub. Date: Dec. 30, 2021

(54) LOCKING FALSE BOTTOM FILTER SIEVE

(71) Applicant: Yangjiang City Xiangmao Trading Co., Ltd., Yangjiang City (CN)

(72) Inventor: Guimin LI, Benxi City (CN)

(21) Appl. No.: 16/915,007

(22) Filed: Jun. 29, 2020

(30) Foreign Application Priority Data
Jun. 28, 2020 (CN) 202021207298.0

(51) Int. Cl. A47J 43/22; B07B 1/02; B07B 1/46

(52) U.S. Cl. CPC A47J 43/22; B07B 1/4672; B07B 1/02

(57) ABSTRACT

The present disclosure provides locking false filter sieve. The filter sieve includes: a sieve body and a base movably connected to the sieve body. The sieve body is machined from a metal sheet into a circular body. An upper circular edge is machined on an upper edge of the circular body by rolling upwards. A groove and a lower circular edge are machined on a lower edge of the circular body by rolling downwards. The upper circular edge and the lower circular edge at a junction of the circular body are mated with each other and movably engaged with each other. Bases having different numbers of meshes body may be mounted by disposing a fastener device at the junction of the circular body. With the above structure, a base having a desired number of meshes may be mounted during use. The structure is reasonable, and highly practicable.

### TECHNICAL FIELD

The present disclosure relates to a locking false bottom filter sieve.

### BACKGROUND

Filter sieves are tools that are commonly used in families to sieve powder. At present, the filter sieves in the related art are mostly integrally machined and inseparable. Now, families tend to use filter sieves having a large number of meshes, for example, 30 meshes for sieving corn powder, 30 to 40 meshes for sieving almond powder, 60 meshes for sieving Chinese traditional medicine powder, 80 to 100 meshes for sieving Sanchi powder, 100 to 120 meshes for sieving Chinese traditional medicine mask powder, and 120 to 150 meshes for sieving pearl powder. Since the conventional filter sieves are integrally manufactured and lack multi-functionality, filter sieves having a plurality of numbers of meshes need to be purchased for sieving these powders, which causes a waste of resources and space. Therefore, it is an inventive concept of the present disclosure to design a locking false bottom filter sieve where a base sieve has any number of meshes replaceable where necessary.

### SUMMARY

To overcome the defects in the related art, the present disclosure is intended to provide a locking false bottom filter sieve which improves working efficiency, saves a lot of space and resources, and has a base filter sieve where the number of meshes are replaceable and is recyclable.

The present disclosure is practiced using the following technical solutions:

According to a technical solution of the present disclosure, a locking false bottom filter sieve is provided. The locking false bottom filter sieve includes:

a sieve body, the sieve body being machined from a metal sheet into a circular body, an upper circular edge being machined on an upper edge of the circular body by rolling upwards, a groove and a lower circular edge being machined on a lower edge of the circular body by rolling downwards, the upper circular edge and the lower circular edge at a junction of the circular body being mated with each other and movably engaged with each other, and the circular body being scaled up or scaled down by disposing a fastener device at the junction of the circular body; and

a base, the base being in a flat circular shape and being formed of a bezel and a filter mesh, the bezel being defined to have a width of 1 mm to 2 cm and bandaged in a periphery of the filter mesh and in contact with the groove, the filter mesh having a number of meshes of 1 to 1000 and being disposed in a middle of the bezel, and the bezel with the filter mesh being received in the groove and locked to a bottom of the circular body by the fastener device.

Further, the fastener device includes a primary fastener piece, a secondary fastener piece, a swing piece, and a connecting piece, the swing piece being movably disposed on the primary fastener piece and fixed to a left side of the circular body, the connecting piece being movably disposed on the secondary fastener piece and fixed to a right side of the circular body, and the swing piece being connected to the connecting piece such that the circular body is scalable up or scalable down by leftward and rightward swinging of the swing piece.

As compared with the prior art, the present disclosure has the following advantages:

With the above structure according to the present disclosure, during use, any base having a desired number of meshes only needs to be mounted, such that the problem of single functionality of the filter sieve in the related art is addressed, and more space and resources are saved. The filter sieve is labor-saving and carefree, and improves economic benefits. The filter sieve according to the present disclosure features reasonable structure, convenient use, high practicability, and is widely applicable to households.

In addition to the above described objects, features, and advantages, the present disclosure still has other objects, features, and advantages. The present disclosure is further described hereinafter with reference to the accompanying drawings.

### BRIEF DESCRIPTION OF THE DRAWINGS

The accompanying drawings herein, which are incorporated herein and constitute a part of the specification, illustrate several exemplary embodiments of the present invention and together with the description, serve to illustrate the present disclosure, construing no limitation to the present disclosure. In the drawings:

FIG. 1 is a schematic structural view of a locking false bottom filter sieve according to a preferred embodiment of the present disclosure;

FIG. 2 is a schematic structural view of a fastener device of the locking false bottom filter sieve according to a preferred embodiment of the present disclosure;

FIG. 3 is a schematic diagram illustrating a base replacement process of the locking false bottom filter sieve according to a preferred embodiment of the present disclosure;

FIG. 4 is a schematic structural view of a sieve body of the locking false bottom filter sieve according to a preferred embodiment of the present disclosure; and

FIG. 5 is a schematic structural view of a base of the locking false bottom filter sieve according to a preferred embodiment of the present disclosure.

### DETAILED DESCRIPTION

It needs to be noted that in case of no conflict, the embodiments and features in the embodiments of the present disclosure may be combined together. The present disclosure is described hereinafter in detail with reference to the accompanying drawings and specific embodiments.

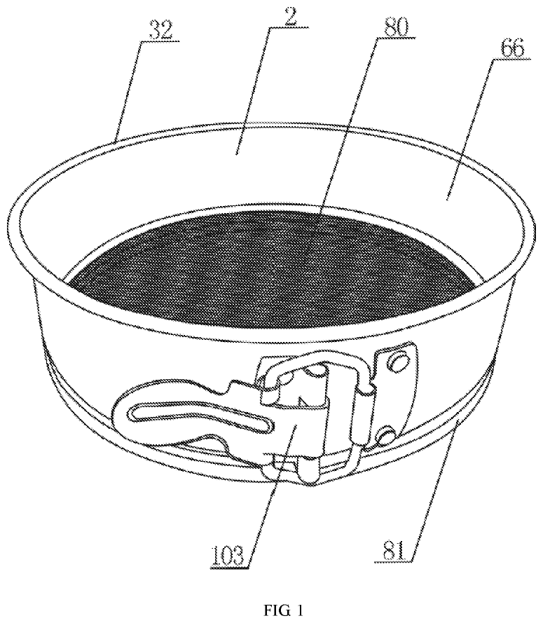

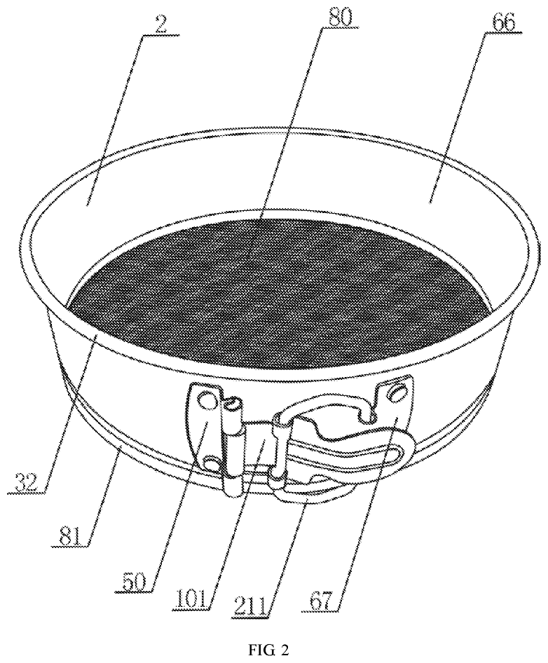

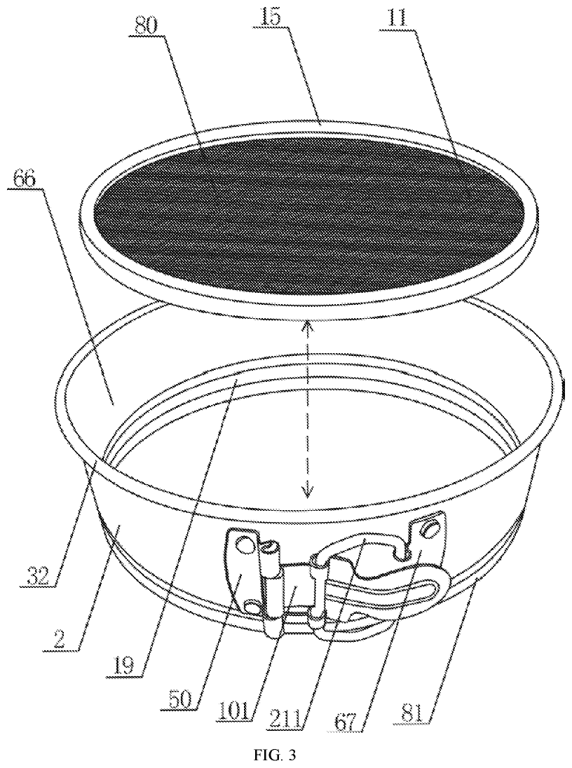

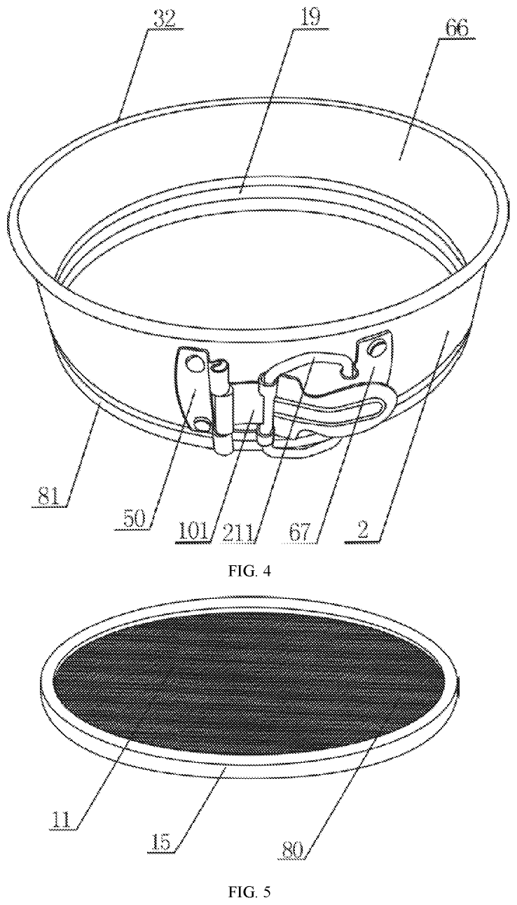

Referring to FIG. 1, FIG. 2, FIG. 3, FIG. 4, and FIG. 5, the present disclosure provides a locking false bottom filter sieve. The locking false bottom filter sieve includes:

a sieve body 2, the sieve body being machined from a sheet-like metal material into a circular body 66, the circular body having resilience and an upper circular edge 32 being machined on an upper edge of the circular body by rolling upwards and in contact with hands, a groove 19 and a lower circular edge 81 being machined on a lower bottom edge of the circular body by rolling downwards, the upper circular edge and the lower circular edge at a junction of the circular body with resilience being correspondingly mated with each other and movably engaged with each other, and under the effect of the resilience, the circular body being scaled up or scaled down by disposing a fastener device 103 at the junction of the circular body; and

a base 80, the base being machined from a metal material, the base being in a flat circular shape and being formed of a bezel 15 and a filter mesh 11, the bezel being machined from a harder material, the bezel being defined to have a width of 1 mm to 2 cm and bandaged in a periphery of the filter mesh and received in the groove, the filter mesh being machined from nylon meshes, copper wires, stainless steel wires or any other suitable metal material, the filter mesh having a number of meshes of 1 to 2000 and being disposed in a middle of the bezel, the number of meshes of the filter mesh being defined according to the size of the filter sieve, and the bezel with the filter mesh being received in the groove and locked to a bottom of the circular body by the fastener device to achieve the effect of replacing the base; wherein the bases are manufactured by the manufacturers to have different numbers of meshes according to customizations of users, and during manufacture, a plurality of bases having the numbers of meshes from 10 to 2000 are packaged together with the sieve body; in this way, the bases having different numbers of meshes may be provided for the users, such that multifunctionality of the filter sieve may be implemented.

Preferably, the fastener device includes a primary fastener piece 50, a secondary fastener piece 67, a swing piece 101, and a connecting piece 211. The swing piece is movably disposed on the primary fastener piece and fixed to a left side of the circular body. The connecting piece is movably disposed on the secondary fastener piece and fixed to a right side of the circular body. The swing piece is connected to the connecting piece such that the circular body is scalable up or scalable down by leftward and rightward swinging of the swing piece. In practice, during use, replacement of the base 80 and mounting of the base 80 may be both practiced by swinging the swing piece leftwards and rightwards. The swing piece is swung rightwards to open the circular body due to the effect of the resilience of the circular body and the base may be replaced, and the swing piece is swung leftwards to lock the base. In this way, bases having different numbers of meshes may be mounted as desired.

The above described embodiments are merely preferred embodiments of the present disclosure, but are not intended to limit the present disclosure. A person skilled in the art would derive various modifications and variations based on these embodiments. Any modification, equivalent replacement, and improvement made without departing from the spirit and principle of the present disclosure shall fall within the protection scope of the present disclosure.

What is claimed is:

1. A locking false bottom filter sieve, comprising:
a sieve body (2), the sieve body being machined from a metal sheet into a circular body (66), an upper circular edge (32) being machined on an upper edge of the circular body by rolling upwards, a groove (19) and a lower circular edge (81) being machined on a lower edge of the circular body by rolling downwards, the upper circular edge and the lower circular edge at a junction of the circular body being mated with each other and movably engaged with each other, and the circular body being scaled up or scaled down by disposing a fastener device (103) at the junction of the circular body; and
a base (80), the base being in a flat circular shape and being formed of a bezel (15) and a filter mesh (11), the bezel being defined to have a width of 1 mm to 2 cm and bandaged in a periphery of the filter mesh and in contact with the groove, the filter mesh having a number of meshes of 1 to 1000 and being disposed in a middle of the bezel, and the bezel with the filter mesh being received in the groove and locked to a bottom of the circular body by the fastener device.

2. The locking false bottom filter sieve according to claim 1, wherein the fastener device comprises a primary fastener piece (50), a secondary fastener piece (67), a swing piece (101), and a connecting piece (211), the swing piece being movably disposed on the primary fastener piece and fixed to a left side of the circular body, the connecting piece being movably disposed on the secondary fastener piece and fixed to a right side of the circular body, and the swing piece being connected to the connecting piece such that the circular body is scalable up or scalable down by leftward and rightward swinging of the swing piece.
